(19) United States
(12) Patent Application Publication
(10) Pub. No.: US 2026/0168468 A1
(43) Pub. Date: Jun. 18, 2026

(54) FUEL ADMISSION MIXER FOR FUMIGATED ENGINE SYSTEM

(71) Applicant: Caterpillar Inc., Peoria, IL (US)

(72) Inventors: James Jay Cress, West Lafayette, IN (US); Ryan Foster Spesard, Camden, IN (US); Darren Steven Szerdy, West Lafayette, IN (US); Andrew C Gaarder, Lafayete, IN (US); Kevin Paul Wobschall, West Lafayette, IN (US); Chetan Vishwanath Kulkarni, West Lafayette, IN (US); Kyle L. Rainey, Mulberry, IN (US)

(73) Assignee: Caterpillar Inc., Peoria, IL (US)

(21) Appl. No.: 18/985,475

(22) Filed: Dec. 18, 2024

(51) Int. Cl. F02M 21/04; F02B 37/00; F02B 43/00

(52) U.S. Cl. CPC F02M 21/04; F02B 37/00; F02B 43/00

(57) ABSTRACT

An engine system includes an intake system having an intake conduit forming an intake passage, and a fuel admission mixer coupled to the intake conduit for fumigation admission of a gaseous fuel. The fuel admission mixer includes a fuel tube forming a feed passage, and a plurality of mixing air admission slots each fluidly connected to the feed passage. Ramming of intake air through the mixing air admission slots can produce vortices of mixing air and admitted gaseous fuel to improve mixing for combustion stability and other purposes. In an embodiment, pressurized air from a compressor of the engine system is returned into the fuel admission mixer.

### TECHNICAL FIELD

The present disclosure relates generally to mixing fuel and air in a fumigated engine system, and more particularly to a fuel admission mixer configured by way of mixing air admission slots to improve fuel-air mixing.

### BACKGROUND

Internal combustion engines are used throughout the world for diverse purposes ranging from operating a driveline in a vehicle to rotating a pump, a compressor, or equipment in an electrical generator. Many will be familiar with the general operating principles of an internal combustion engine whereby a controlled combustion of a fuel and air is utilized to drive a piston that rotates a crankshaft. Internal combustion engines are known which operate on various different fuel types and fuel delivery strategies. Engine design, operation, ignition, and control strategies can all vary widely depending upon the composition of the fuel and how the fuel is delivered into an engine cylinder for combustion. Compression-ignition diesel engines, for example, are typically directly injected, and autoignite a diesel fuel in the cylinders. Gasoline engines and gaseous fuel engines, commonly operating on various gaseous hydrocarbon fuels or blends, typically utilize spark-ignition. Other engine variations include dual gaseous and liquid fuel engines, prechamber-ignited engines, and still others.

Gaseous fuel engines, notably natural gas engines, are often employed in scenarios where natural gas is plentiful and/or economically advantageous. Gaseous fuel engines also tend to produce relativity lower levels of certain emissions, notably particulate matter. Platforms are known where natural gas, or another gaseous fuel such as other hydrocarbon fuels, gaseous molecular hydrogen, or various blends, is directly injected into engine cylinders or injected into intake ports extending to the cylinders. Still other engine platforms are operated by way of so-called fumigation, where the gaseous fuel is sucked into an intake system of the engine and mixed with air prior to reaching the cylinders. Gaseous fuel engines, including fumigated engines, are often operated stoichiometrically quite lean, providing certain advantages but also created challenges respecting mixing and combustion stability. One known engine system that can apparently be operated by way of fumigation is known from U.S. Pat. No. 11,035,334 B1 to Cress et al.

### SUMMARY

In one aspect, an engine system includes an intake conduit forming an intake passage defining an intake passage center axis and extending in an upstream to downstream direction from an upstream air inlet to a downstream air-fuel outlet. The intake conduit includes a fuel admission port located between the upstream air inlet and the downstream air-fuel outlet. The engine system also includes a fuel admission mixer coupled to the intake conduit and having a fuel tube extending through the fuel admission port and projecting into the intake passage. The fuel tube forms a feed passage extending to a distal fuel outlet, and a plurality of mixing air admission slots each fluidly connected to the feed passage and opening in an upstream direction.

In another aspect, a fuel admission mixer for a gaseous fuel engine system includes a mounting flange portion forming a fuel inlet, and a fuel tube extending from the mounting flange portion and having a tube wall including an inner tube surface and an outer tube surface. The inner tube surface extends circumferentially around a feed passage center axis, and forms a feed passage for feeding gaseous fuel from the fuel inlet to a distal fuel outlet. The tube wall includes a back wall portion extending part-circumferentially around the feed passage center axis, and a front wall portion extending part-circumferentially around the feed passage center axis. The front wall portion is slotted and forms a plurality of mixing air admission slots extending from the outer tube surface to the inner tube surface, for admitting mixing air to the feed passage, each elongated in a circumferential direction, and the back wall portion is unslotted.

In still another aspect, a method of operating an engine system includes admitting a gaseous fuel via fumigation into a fuel admission mixer fluidly connected to an intake conduit extending to an engine. The method further includes ramming mixing air into a feed passage of the fuel admission mixer through a plurality of mixing air admission slots of the fuel admission mixer, and producing vortices of mixing air and gaseous fuel, based on the ramming of the mixing air. The method further includes conveying the mixing air and gaseous fuel into the intake conduit for combustion in the engine.

### BRIEF DESCRIPTION OF DRAWINGS

FIG. 1 is a diagrammatic view of an engine system, according to one embodiment;

FIG. 2 is a diagrammatic view of portions of the engine system, as in FIG. 1, and including a fuel admission mixer, according to one embodiment;

FIG. 3 is a side diagrammatic view of a fuel admission mixer in service, according to one embodiment;

FIG. 4 is an upstream to downstream view, in cutaway, of a fuel admission mixer in service, according to one embodiment;

FIG. 5 is another side diagrammatic view of a fuel admission mixer in service, according to one embodiment; and

FIG. 6 is a side diagrammatic view of a fuel admission mixer in service, according to another embodiment.

### DETAILED DESCRIPTION

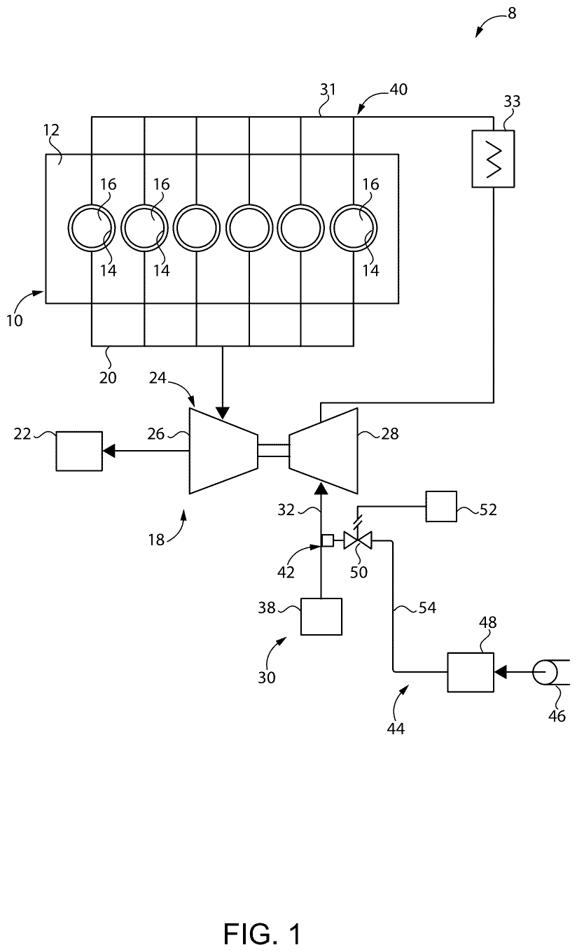

Referring to FIG. 1, there is shown a gaseous fuel internal combustion engine system 8, according to one embodiment. Engine system 8 includes a gaseous fuel internal combustion engine 10 having an engine housing 12 with a plurality of cylinders 14 formed therein. Cylinders 14 can include any number in any suitable arrangement such as an in-line pattern, a V-pattern, or still another. Pistons 16 are positioned in cylinders 14 and movable in a generally conventional manner to provide power to a load. Engine system 8 can be used in any known engine application, including operating a driveline in a land vehicle or a marine vessel, operating a pump, a compressor, or an electrical generator, for example. Engine system 8 also includes an exhaust system 18 having an exhaust manifold 20 structured to feed exhaust from combustion of a fuel and air in cylinders 14 to exhaust outlet 22. A turbocharger 24 includes a turbine 26 rotated by way of a feed of exhaust from engine 10, coupled to a compressor 28 structured to pressurize intake air, and typically a mixture of intake air and a gaseous fuel, as further discussed herein.

Engine system 8 also includes an intake system 30. Intake system 30 includes an intake manifold 31, and an intake conduit 32 that extends to intake manifold 31, typically by way of an aftercooler 33. Engine system 8 also includes a fuel system 44. Fuel system 44 includes a fuel supply 46, which may include a gaseous fuel supply containing or supplying a gaseous fuel. A gaseous fuel within the context of the present disclosure might include natural gas, methane, ethane, biogas, landfill gas, gaseous molecular hydrogen, or various blends of these or still others. A gaseous fuel supply conduit 54 extends between fuel supply 46 and intake conduit 32. Conditioning equipment 48 including, for example, filtration equipment 48, may be positioned between fuel supply 46 and intake conduit 32. Fuel system 44 may also include a gaseous fuel admission valve 52, electrically actuated, and structured to be controlled by way of an electronic control unit or ECU 52.

In the illustrated embodiment, engine system 8 is fueled by way of fumigation, such that rotation of compressor 28 draws intake air into intake conduit 32 by way of an upstream air inlet 38, and pressurizes the air and supplies the same to a downstream air-fuel outlet 40. Fuel, including a gaseous fuel, is drawn into intake conduit 32 by way of a fuel admission port 42 located between upstream air inlet 38 and downstream air-fuel outlet 40, according to generally known principles.

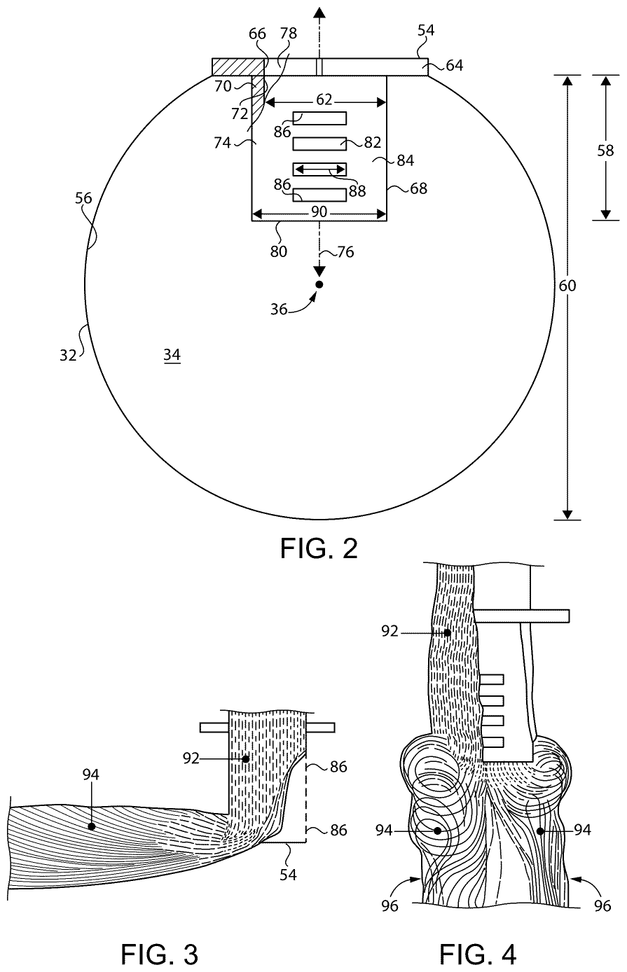

Referring also now to FIG. 2, intake conduit 32 forms an intake passage 34 defining an intake passage center axis 36. Intake conduit 32 extends in an upstream to downstream direction from upstream air inlet 38 to downstream air-fuel outlet 30. Intake system 30 also includes a fuel admission mixer 54 to assist in mixing gaseous fuel admitted into intake conduit 32 with air for combustion. It has been observed that enhanced mixing of gaseous fuel and air can be associated with improved performance of an internal combustion engine, including improved combustion stability and potentially improvements in other factors.

Fuel admission mixer 54 is coupled to intake conduit 32 and includes a fuel tube 68. Fuel tube 68 extends from a mounting flange portion 64 forming a fuel inlet 66 through fuel admission port 42. Thus, during operating engine system 8 rotation of compressor 28 can draw in gaseous fuel from fuel supply 46 whenever gaseous fuel admission valve 50 is open. As will be further apparent from the following description, fuel admission mixer 54 is uniquely structurally configured to assist in enhancement and improvement of fuel and air mixing.

Fuel admission mixer 54 may be mounted upon intake conduit 32 such as by clamping, bolting, welding, or any other suitable fixation strategy. As can be seen from FIG. 2, fuel tube 68 projects into intake passage 34. Intake conduit 32 includes an inner surface 56 forming intake passage 34. Fuel tube 68 projects toward intake passage center axis 36 to a location in intake passage 34 short of intake passage center axis 36 in the illustrated embodiment. Put differently, fuel tube 68 may extend toward axis 36 but not so far as to reach or be intersected by axis 36, at least in some embodiments.

Fuel tube 68 may further include a tube wall 70 having an inner tube surface 72 and an outer tube surface 74. Inner tube surface 72 may be cylindrical and extends circumferentially around a feed passage center axis 76. Inner tube surface 72 forms a feed passage 78 for feeding gaseous fuel from fuel inlet 66 to a distal fuel outlet 80. Distal fuel outlet 80 may be generally circular in some embodiments and is formed in an open distal or outermost end of fuel tube 68. Tube wall 70 may also include a back wall portion 82 extending part-circumferentially around feed passage center axis 76, and a front wall portion 84 extending part-circumferentially around feed passage center axis 76. Back wall portion 82 faces generally a downstream direction and front wall portion 84 faces generally an upstream direction. Back wall portion 82 and front wall portion 84 may each extend approximately half-way around feed passage center axis 76.

Front wall portion 84 is slotted and forms a plurality of mixing air admission slots 86. Mixing air admission slots 86 extend from outer tube surface 74 to inner tube surface 72, for admitting mixing air from intake passage 34 into feed passage 78 as further discussed here. Each mixing air admission slot 86 may be elongated in a circumferential direction around feed passage center axis 76. Back wall portion 82 may be unslotted, and in one practical implementation strategy is solid, meaning opaque to a flow of fluid. Thus, it will be appreciated that slotted front wall portion 84 permits admission of mixing air whilst unslotted backwall portion 82 does not permit passage of mixing air and/or fuel, and thus assists in directing a stream of admitted gaseous fuel and admitted mixing air downward in the FIG. 2 illustration and into intake passage 34.

Also in a practical implementation, mixing air admission slots 86 may have a regular distribution in wall 70. The regular distribution may include a radial distribution relative to intake passage center axis 36. Mixing air admission slots 86 may be non-circular, and in the illustrated embodiment are rectangular. A total number of the plurality of mixing air admission slots 86 may be from two to six, potentially from two to five, and in one refinement four in total number as illustrated.

As discussed above, obtaining optimal mixing of gaseous fuel and air, particularly in a fumigated lean-burn gaseous fuel engine system, can be challenging. It has been discovered that circumferentially extending mixing air admission slots, potentially in combination with other geometric attributes of a fuel admission mixer, can provide practical and advantageous mechanisms for achieving optimum mixing of gaseous fuel and air. One attribute related to the construction and positioning of fuel admission mixer 54 relates to a projection distance of fuel admission mixer 54 into intake conduit 32.

In FIG. 2, numeral 58 shows a fuel tube projection distance “L” of fuel tube 70. Numeral 60 shows an intake conduit inner diameter dimension “D” of intake conduit 32. Numeral 62 shows a fuel tube inner diameter dimension “d” of fuel tube 79. It will be recalled fuel tube 80 may project to a location short of intake passage center axis 36. A fuel tube projection distance that is too far, or a fuel tube projection distance that is too short, may have suboptimal and/or unpredictable results. A fuel tube projection distance that provides acceptable and potentially advantageous results may be selected according to the following Equation 1:

L=D/2−d*c;
where: L=the fuel tube projection distance;
   D=the intake conduit inner diameter dimension;
d=the fuel tube inner diameter dimension; and
c=˜0.4 to ˜0.6.

In some embodiments c=˜0.5, more particularly exactly 0.5 within measurement error. Relative terms such as “about” or “approximately” as used herein mean generally, as would be understood by a person of ordinary skill in the art, for example, applying conventional rounding.

Additional features of fuel admission mixer 54 that can assist in obtaining practical and potentially advantageous results relate to proportions of fuel admission slots 86 relative to an inner diameter size of fuel tube 70. In FIG. 2, numeral 88 shows a fuel admission slot arc length wₐₗ. Numeral 90 shows a half circumference of a circle centered on feed passage center axis 76 Wₐₗ, the circle being defined by and centered on tube inner surface 72. An arc length of mixing air admission slots that provides acceptable and potentially advantageous results may be selected according to the following Equation 2:

wₐₗ=K*W_{al;}
where: wₐₗ=the fuel admission slot arc length;
Wₐₗ=half circumference of the circle; and
K=˜0.2 to ˜0.4.

In some embodiments K=˜0.28, more particularly exactly 0.28 within measurement error.

### INDUSTRIAL APPLICABILITY

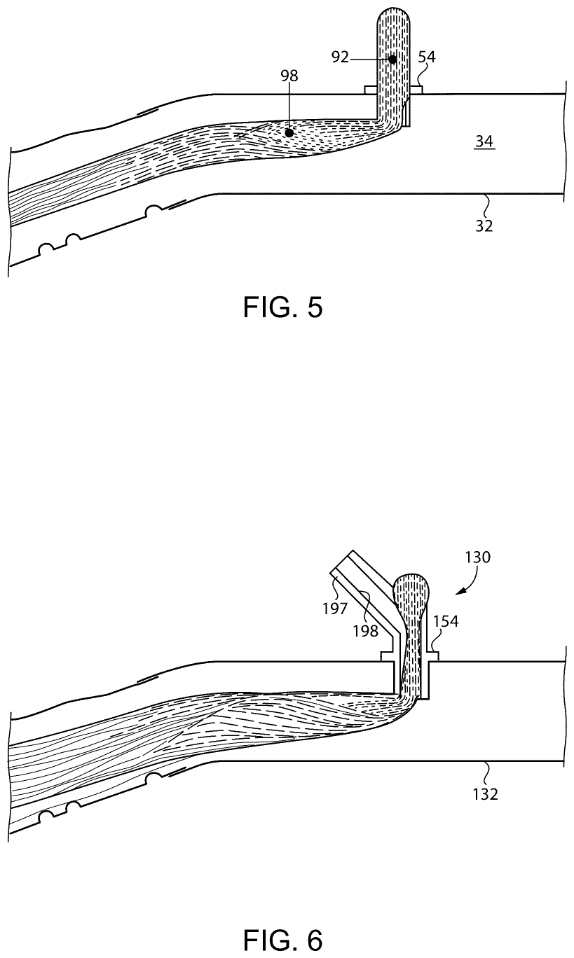

Referring also now to FIG. 3, there is shown fuel admission mixer 54 in service receiving admission of a charge of a gaseous fuel shown at numeral 92. Mixing air in intake conduit 32 has been rammed through mixing air admission openings 86 and into feed passage 78. FIG. 4 shows in cutaway where fuel 92 can be seen to be advancing through feed passage 78 and mixing with air 94 via two vortices 96. FIG. 5 shows fuel admission mixer 54 in service at state that might exist shortly after the states depicted in FIGS. 3 and 4, and where it can be seen that mixed fuel and air 98 is traveling through intake passage 94 toward engine 12.

FIG. 6 shows an alternative embodiment, employing a fuel admission mixer 154 extending into an intake conduit 132 in an intake system 130. Fuel admission mixer 154 may be constructed generally analogously or identically to fuel admission mixer 54 discussed above but includes an additional fitting or inlet pipe 197 forming a compressor return passage or conduit 198. Compressor return conduit 198 can supply a feed of pressurized air from a compressor of a turbocharger in an associated engine system to further enhance mixing of fuel and air.

Operating engine system 8 generally may include admitting a gaseous fuel via fumigation into a fuel admission mixer 54 fluidly connected to an intake conduit 32 extending to an engine 12. Operating engine system 8 can further including ramming mixing air into feed passage 78 of fuel admission mixer 54 through the plurality of mixing air admission slots 86, so as to produce vortices of the mixing air and gaseous fuel based on the ramming of the mixing air. The mixed air and gaseous fuel is thenceforth conveyed into the associated intake conduit 32 for combustion in engine 10, typically by way of spark-ignition. Operating an engine system employing the embodiment of FIG. 6 may be similar, with the additional pressurized air from compressor return conduit 198 provided to further enhance fuel and air mixing.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. An engine system comprising:
an intake conduit forming an intake passage defining an intake passage center axis and extending in an upstream to downstream direction from an upstream air inlet to a downstream air-fuel outlet, and including a fuel admission port located between the upstream air inlet and the downstream air-fuel outlet;
a fuel admission mixer coupled to the intake conduit and including a fuel tube extending through the fuel admission port and projecting into the intake passage; and
the fuel tube forming a feed passage extending to a distal fuel outlet, and a plurality of mixing air admission slots each fluidly connected to the feed passage and opening in an upstream direction.

2. The engine system of claim 1 further comprising a gaseous fuel supply conduit, and a gaseous fuel admission valve to admit a gaseous fuel to the fuel admission mixer.

3. The engine system of claim 2 further comprising a compressor, and a compressor return conduit fluidly connected to the fuel admission mixer to supply pressurized air to the feed passage thereof.

4. The engine system of claim 1 wherein the feed passage defines a feed passage center axis oriented transverse to the intake passage center axis.

5. The engine system of claim 4 wherein the intake conduit includes an inner surface forming the intake passage, and the fuel tube projects toward the intake passage center axis to a location in the intake passage short of the intake passage center axis.

6. The engine system of claim 5 wherein the fuel tube defines a projection distance into the intake conduit according to the following Equation 1:
L=D/2−d*c;
where: L=the fuel tube projection distance;
D=an intake conduit inner diameter dimension;
d=a fuel tube inner diameter dimension; and
c=˜0.4 to ˜0.6.

7. The engine system of claim 4 wherein the plurality of mixing air admission slots are elongate circumferentially around the feed passage center axis, and have a radial distribution relative to the intake passage center axis.

8. The engine system of claim 7 wherein the plurality of mixing air admission slots are non-circular, and the radial distribution includes a regular radial distribution.

9. The engine system of claim 8 wherein the plurality of mixing air admission slots are rectangular, and a total number of the plurality of mixing air admission slots is from two to six.

10. The engine system of claim 7 wherein each of the plurality of mixing air admission slots defines an arc length on a circle centered on the feed passage center axis according to the following Equation 2:
wₐₗ=K*W_{al;}
where: wₐₗ=fuel admission slot arc length;
Wₐₗ=half circumference of the circle; and
K=˜0.2 to ˜0.4.

11. The engine system of claim 1 further comprising a gaseous fuel internal combustion engine.

12. A fuel admission mixer for a gaseous fuel engine system comprising:
a mounting flange portion forming a fuel inlet;
a fuel tube extending from the mounting flange portion, and including a tube wall having an inner tube surface, and an outer tube surface;
the inner tube surface extending circumferentially around a feed passage center axis, and forming a feed passage for feeding gaseous fuel from the fuel inlet to the distal fuel outlet;
the tube wall includes a back wall portion extending part-circumferentially around the feed passage center axis, and a front wall portion extending part-circumferentially around the feed passage center axis; and
the front wall portion is slotted and forms a plurality of mixing air admission slots extending from the outer tube surface to the inner tube surface, for admitting mixing air into the feed passage, each elongated in a circumferential direction, and the back wall portion is unslotted.

13. The fuel admission mixer of claim 12 wherein the plurality of mixing air admission slots have a regular distribution in the tube wall.

14. The fuel admission mixer of claim 13 wherein a number of the plurality of mixing air admission slots is from two to six, and the back wall portion is solid.

15. The fuel admission mixer of claim 12 wherein each of the plurality of mixing air admission slots is rectangular.

16. The fuel admission mixer of claim 12 wherein each of the plurality of mixing air admission slots defines an arc length of a circle centered on the feed passage center axis.

17. The fuel admission mixer of claim 16 wherein the arc length defined by each of the mixing air admission slots includes an arc length according to the following Equation 2:
wₐₗ=K*W_{al;}
where: wₐₗ=fuel admission slot arc length;
Wₐₗ=half circumference of the circle; and
K=˜0.28.

18. The fuel admission mixer of claim 12 further comprising a compressor return conduit fluidly connected to the fuel admission mixer to supply pressurized air to the feed passage thereof.

19. A method of operating an engine system comprising:
admitting a gaseous fuel via fumigation into a fuel admission mixer fluidly connected to an intake conduit extending to an engine;
ramming mixing air into a feed passage of the fuel admission mixer through a plurality of mixing air admission slots in the fuel admission mixer;
producing vortices of the mixing air and gaseous fuel based on the ramming of the mixing air; and
conveying the mixing air and gaseous fuel into the intake conduit for combustion in the engine.

20. The method of claim 19 further comprising conveying pressurized air returned from a compressor into the feed passage of the fuel admission mixer.
